(19) United States
(12) Patent Application Publication
(10) Pub. No.: US 2009/0142171 A1
(43) Pub. Date: Jun. 4, 2009

(54) MOVABLE LOAD CAPABLE OF WITHSTANDING LATERAL FORCES

(76) Inventors: Frank K. Weigand, La Canada, CA (US); Aidan J. Bradley, Westlake Village, CA (US); Jeff Anderson, Saugus, CA (US); Gabriel T. Manville, Santa Rosa, CA (US)

Correspondence Address: K&L Gates LLP, P.O. BOX 1135, CHICAGO, IL, 60690, US

(21) Appl. No.: 11/949,556

(22) Filed: Dec. 3, 2007

(51) Int. Cl. B60P 1/00

(52) U.S. Cl. 414/467; 414/785

(57) ABSTRACT

The present invention relates to a load. The load can include a perimeter with a first side and a second side, the second side extending substantially parallel to the first side and a plurality of supports extending from the first side to the second side, the supports allowing the load to withstand a lateral compression force suitable to lift the load.

### BACKGROUND

The prior art is generally directed to transporting a load by a flat bed delivery device, such as a truck or other device. The prior art loads are delivered via delivery devices that generally attempt to locate the loads onto or adjacent a site or other area prior to the load being unloaded from the transport vehicle. The load is then slid off the transporter or lifted off via a crane.

### SUMMARY

The present invention relates to a load. The load can include a perimeter with a first side and a second side, the second side extending substantially parallel to the first side and a plurality of supports extending from the first side to the second side, the supports allowing the load to withstand a lateral compression force suitable to lift the load.

The present invention also relates to a movable structure. The movable house can include a substantially complete full size non-roadable house and a foundation coupled to the substantially complete full size non-roadable house. The foundation can include a perimeter including a first side and a second side, the second side extending substantially parallel to the first side, and a plurality of supports extending from the first side to the second side, the supports allowing the foundation to withstand a lateral compression force suitable to lift the load.

The present invention also relates to a load. The load can includes a perimeter including a first side and a second side, the second side extending substantially parallel to the first side, a plurality of openings in the first and second sides, the plurality of openings on the first side aligned with a respective opening on the second side, a plurality of supports extending from the first side to the second side, the supports allowing the load to withstand a lateral compression suitable to lift the load, and a plurality of tendons extending through the plurality of openings in the first and second sides, the plurality of tendons allowing the load to be lifted and moved.

Additional features and advantages are described herein, and will be apparent from, the following Detailed Description and the figures.

### BRIEF DESCRIPTION OF THE FIGURES

FIG. 1 is a top perspective view of a load, according to one embodiment of the present invention, on a transport vehicle with one of the load bearing structures removed;

FIG. 2 is a top perspective view in section of a tendon for the tensioning system for the transport vehicle extending through a beam;

FIG. 3 is an enlarged view of a tendon located adjacent the load for the tensioning system for the transport vehicle extending through an open portion of the load;

FIG. 4 is a top perspective view of the load of FIG. 1 on a transport vehicle;

FIG. 5 is a top view of a load and transport vehicle shown in FIG. 4;

FIG. 6 is a side elevational view of a transport vehicle shown in FIG. 5;

FIG. 7 is an enlarged view of another embodiment showing the tendon located adjacent the load of the tensioning system for the transport vehicle;

FIG. 8 is a schematic view of the tensioning system for the transport vehicle;

FIG. 9 is a partial side view of one of a load bearing structures for the transport vehicle shown in FIG. 4;

FIG. 10 is an enlarged view the lifting mechanism and the drive mechanism located at one end of load bearing structures shown in FIG. 9;

FIG. 11 is a schematic view of a system configured to drive and steer the bogies of the vehicle shown in FIG. 4;

FIG. 12 is a schematic view of a system configured to maintain a load in a substantial planar and substantial level orientation according to one embodiment of the present invention;

FIG. 13 is a schematic top view representation of the load and vehicle positioned over an existing site;

FIG. 14 is a schematic end view representation of the load and vehicle of FIG. 13; and

FIG. 15 is a schematic side view representation of the vehicle of 14 lowering the load onto the existing site.

### DETAILED DESCRIPTION

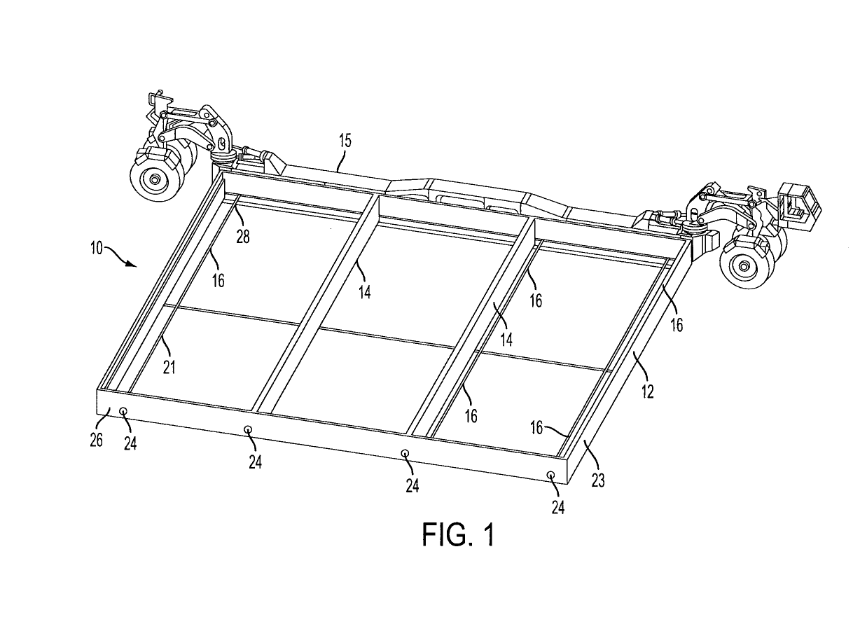

FIGS. 1-3 illustrate a load 10 according to one embodiment of the present invention. The load can be a movable foundation that has a perimeter 12 with support structures or horizontal beams 14 sufficient to facilitate the load withstanding a horizontal or lateral forces during transport. The load can be transported using vehicle 15 that couples to the load using a tension/compression system 18 that utilizes tendons or bands 16.

Load 10 can be any suitable load to be moved. For example, the load can be a building, a building foundation, a truck container, a box, a carton, a pallet or any other suitable load or combination of loads. Building is defined as any completed, substantially completed or partially completed structure capable of permanent, semi-permanent or temporary occupancy or a house or other large rigid or semi-rigid payload. For example, a house can be a full sized custom home too large to be transported on public roads, a double wide or triple wide mobile home or any other structure desired. When configured as a building or substantially completed house, the load can include a foundation 22 coupled to the building, such that the building can be positioned in any suitable place that can accommodate such a foundation.

The load can have structures or beams 14 that help the load withstand a lateral force, such that the load 10 can be lifted using the compression/tension system and method described herein. The load can have a perimeter 23 that is formed in any shape desired. Both the perimeter 23 and beams 14 can be formed from concrete, metal, wood or any other suitable material or combination of materials. Furthermore, the perimeter and beams can include rebar and be integral for separate from each other. When separate, the beams can couple to the perimeter in any suitable manner, including friction or in any other temporary, permanent or semi-permanent manner. It is noted that the load does not need to have beams 14, and can have any suitable device or structure that would help the load withstand the necessary compression.

The load 10 can also have three (or any suitable number of) fixtures 21 running lengthwise and/or widthwise and/or in any suitable direction that support the tendons and accurately locate them relative to one another. These fixtures are built into the load and stay with it until the vehicle picks up the load. At that point, if desired, the fixtures can be removed from the load and reused. The fixtures can be removed at any other desired time or remain permanently with the load.

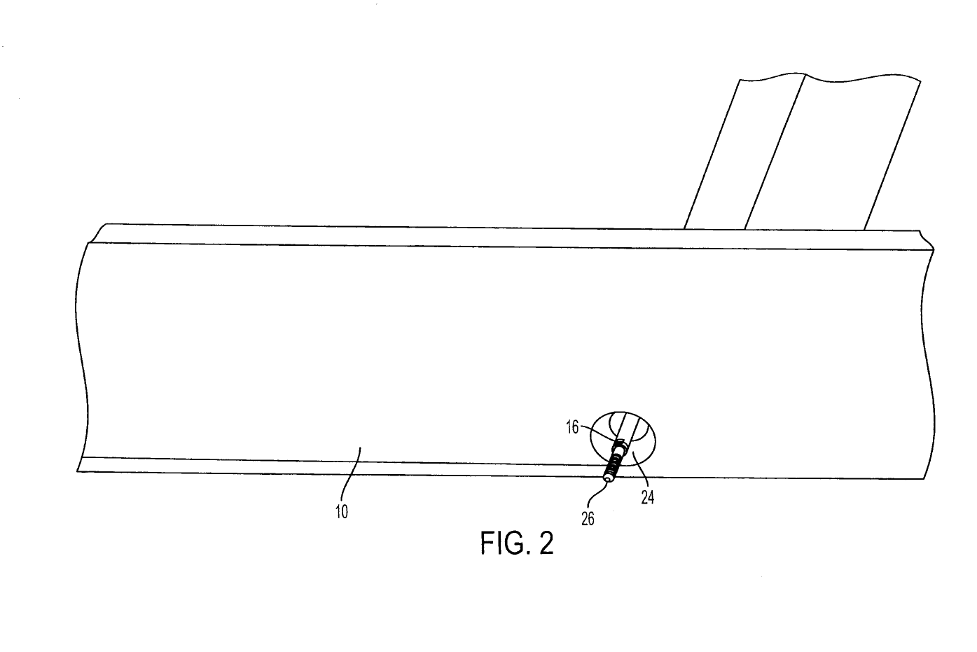

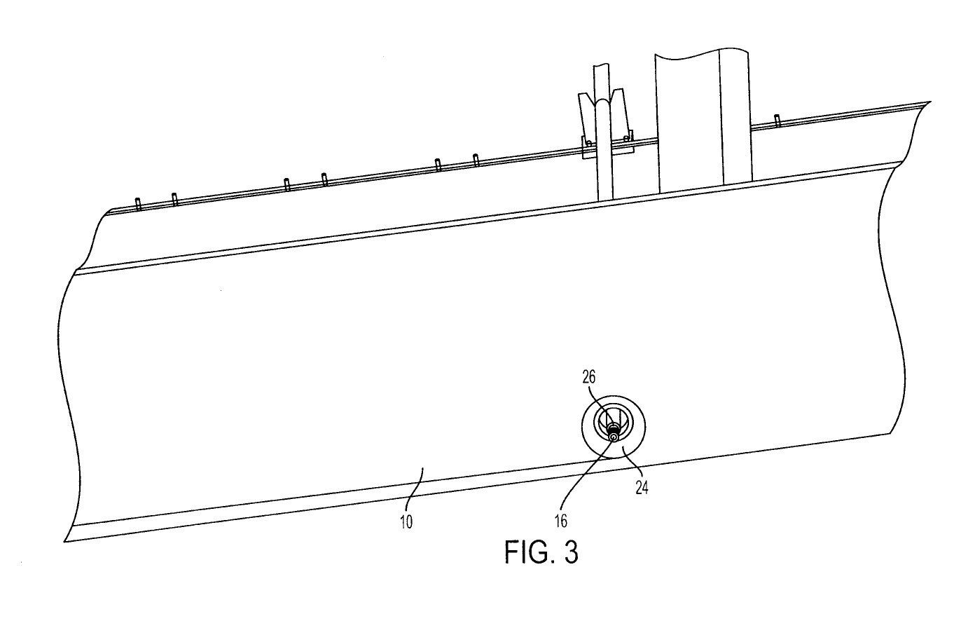

As shown in FIGS. 2 and 3, load 10 preferable has openings or areas 24 that extend through a portion thereof. In this particular embodiment, the openings 24 pass through the load; however the openings can pass through any portion of the load or merely pass adjacent the load and not through the load.

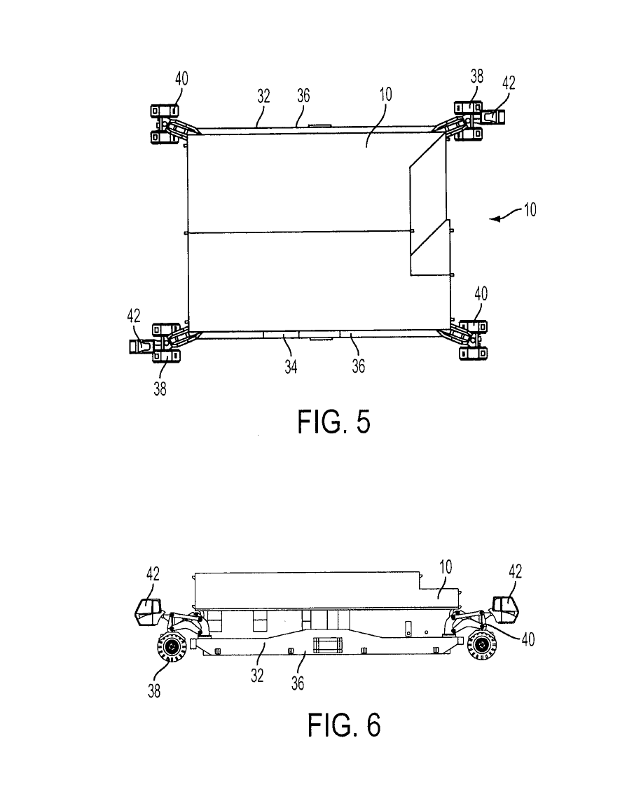

As shown in FIGS. 2 and 3, bands 16 are preferably metal tubes that can be any suitable length and/or diameter. For example, the bands can extend the entire width of the load, plus several feet beyond the load for gripping purposes or each band can be divided into multiple connectable segments (e.g., 10 foot segments), thus allowing easier retraction in confined areas. There are preferably about four (4) bands, and each of the bands has a first end 26 and a second end 28; however, any number of suitable bands can be used. For example, one band or any number of a plurality of bands can be used. The bands 16 can be formed from any suitable material. For example, bars made by DYWIDAG can be suitable or other suitable high strength bars. Furthermore, bands 16 can be configured in any suitable shape or configuration and they can be hollow, partially hollow, solid or substantially solid or any variation or combination thereof or in any suitable or desirable manner. The bands may pass through any portion of the load. For example, as shown in FIG. 5, the band 16 extends or passes through the structure 24 or as shown in FIG. 6, the band merely pass though the outer perimeter of the load and then through the interior open space thereof. However, the bands can pass through any suitable portion of the load or merely adjacent or near the load, if desired.

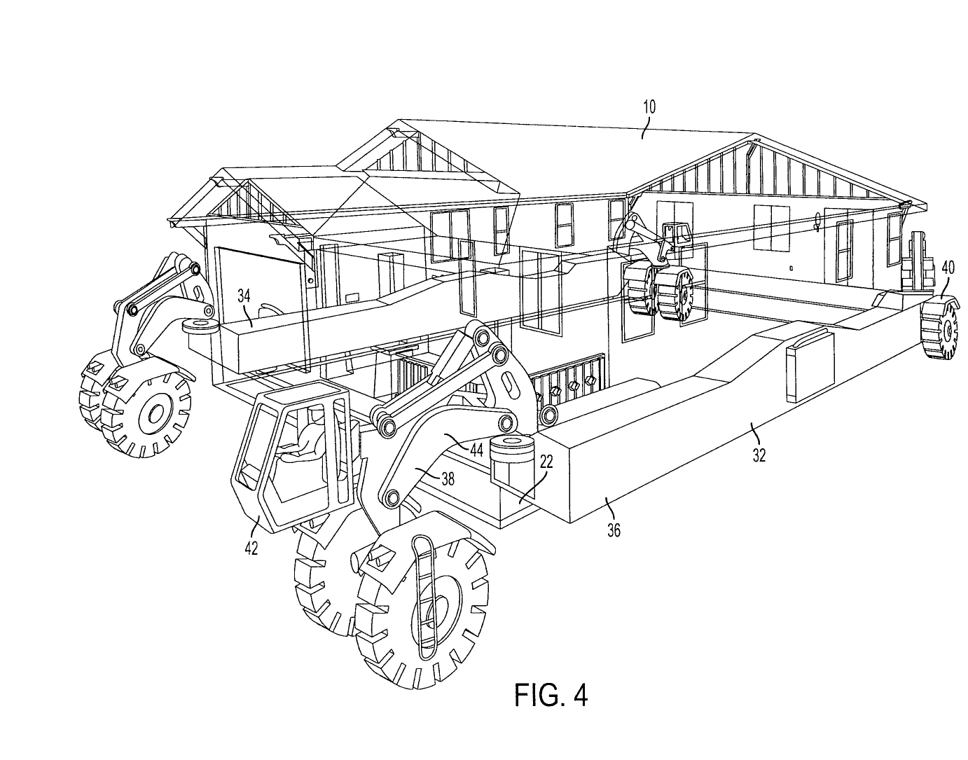

As shown in the FIGS. 4-6, preferably the load 10 is moved by a vehicle 30 formed from two separate vehicles 32 and 34 that connect or couple with load 10 to form a vehicle mover. Preferably, the first and second vehicles or portions 32 and 34 are substantially similar and can either operate alone or in combination. Therefore, the description of vehicle 32 is applicable to both vehicles 32 and 34; however, the vehicles can each be designed in any suitable manner and do not necessarily need to be substantially similar.

As shown in FIGS. 4-6, each vehicle preferably includes a truss or chassis 36, a first bogie 38, a second bogie 40 and a control station 42. The first bogie is coupled or attached to the chassis by a lifting mechanism or means 44 and the second bogie is coupled or attached to a second lifting mechanism or means. The chassis 36 is preferably manufactured from welded plate sections but can be any suitable design and/or configuration, such as being manufactured from welded tubes. Each chassis is generally about 60 feet long, about 44 inches wide, about 92 inches high and weighs approximately 40,000 pounds, including internal equipment; however the chassis can have any suitable dimensions and/or weight as appropriate for the building or load size and weight. Preferably chassis 36 is designed and configured to provide minimal loaded deflection and cope with torsional load when the bogies are offset.

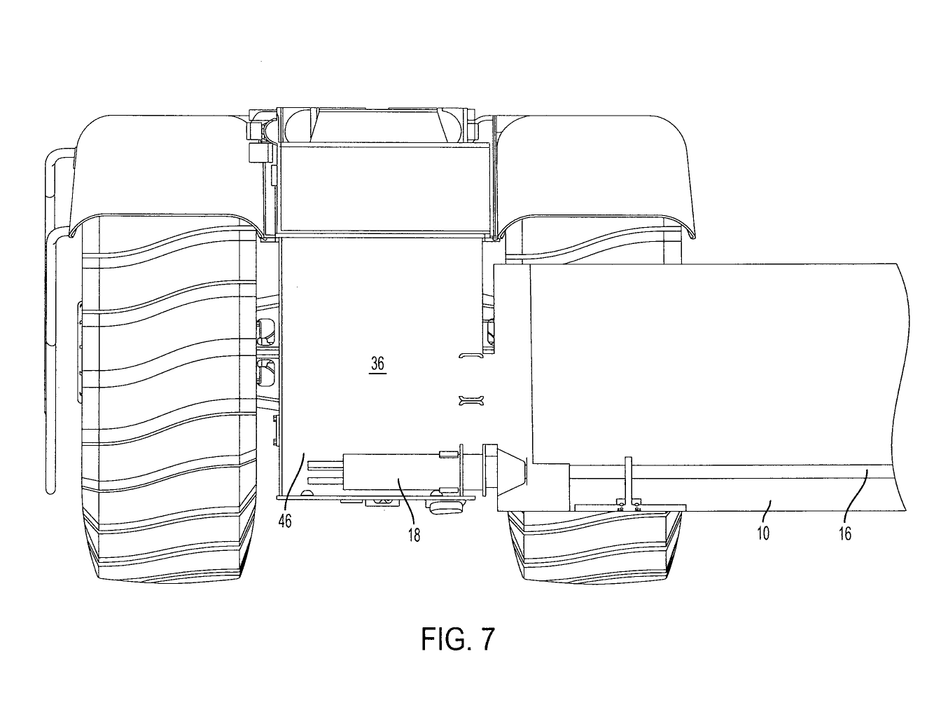

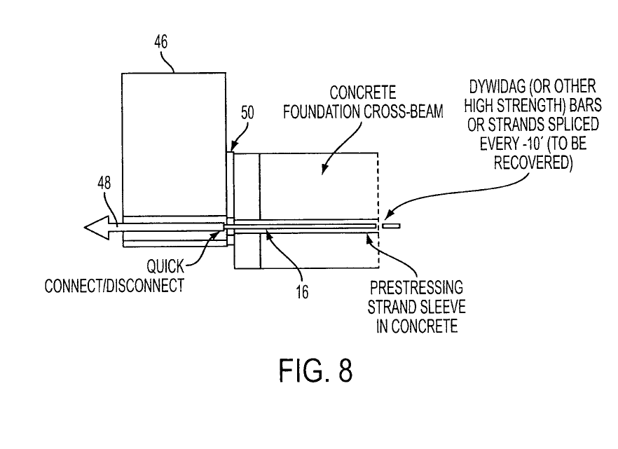

As shown in FIG. 7 and 8, once the two independent vehicles 32 and 34 are located adjacent the load 10, the tensioning means is activated, such that the load can be lifted. The tension means includes at least one tensioning device 18, which couples to at least one band 16. Bands 16 are coupled to the tensioning devices by inserting the first and second ends of bands 16 into a respective tensioning device 18. If desired, each of the first and second vehicles 32 and 34 can include at least one camera adjacent the bands 16 to facilitate coupling to the bands to the vehicles 32 and 34. If necessary, the bands can bend to take up vertical and longitudinal misalignment. Tensioning device 18 can be a hydraulic actuator or any other suitable device. Preferably, there are eight (8) tensioning devices (one to couple with each end of a band); however, there can be any suitable number of tensioning devices. Tensioning device 18 can be mounted on an outside face of a box beam 46 in the chassis 36. Holes can then be formed in the chassis 36 to allow bands to extend therethrough and into the tensioning device.

The tensioning devices are then actuated pulling bands 16 in the direction of arrow 48. The tensioning devices draw the chassis toward the load and compress the load between the chassis. Each chassis can have a high friction interface 50. The high friction interface can extend along the entire, substantially the entire or any portion of the chassis facing the load. For example the high friction interface can be a series of pads positioned along the chassis. Each of the tensioning devices each can produce about 150,000 pounds of tension; however the tensioning devices can provide any suitable amount of tension.

The tension created by the tensioning devices creates significant compression between the load and the two chassis (or the friction interface). This compression/friction allows the lifting mechanisms to lift and move the load. Once a sufficient compression force is created, the load can be lifted. Preferably, the compression force should be sufficient to lift the load and withstand any dynamic loads incurred during transport. For example, the compression force can be less than the weight of the load or any suitable amount.

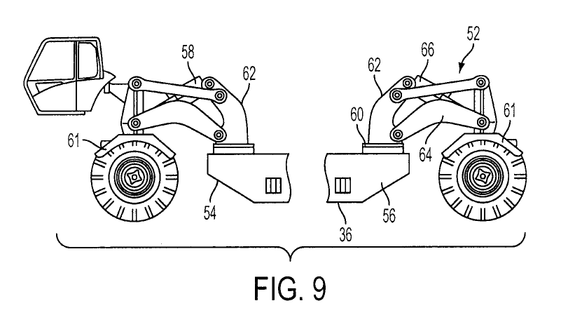

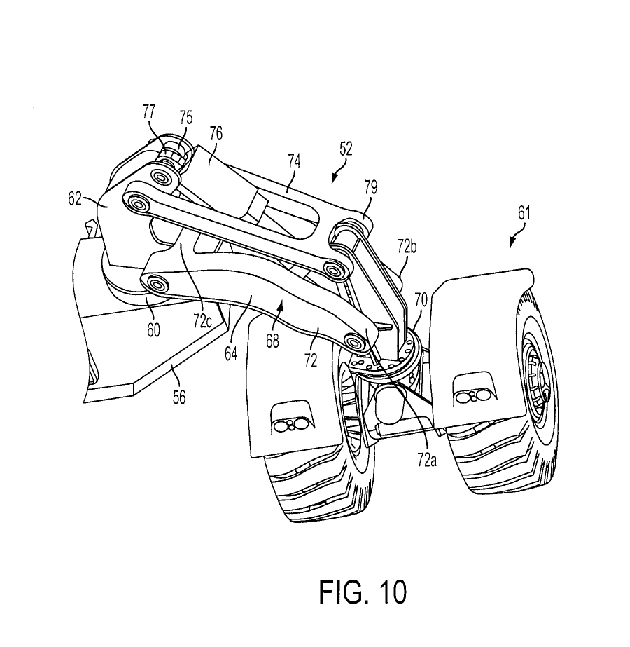

The load can be lifted using the lifting mechanism 52 shown in FIGS. 9 and 10. The lifting mechanism is coupled to chassis 36 at a first end 54 and a second end 56, each of which is coupled to a respective lifting mechanism via actively articulated slewing ring bearings 58 and 60, respectively. The ring bearings do not necessarily need to be actively articulated and can be any bearings desired. Furthermore, the chassis can be coupled to a respective bogie 61 in any suitable manner. Preferably, each lifting mechanism or means can include a protrusion 62, a linkage 64 and an actuator 66; however the lifting mechanism or means can have any suitable structure. Additionally, the structure of the lifting mechanism or means does not need to have the exact structure of the protrusion, linkage and actuator and each of these elements can have any suitable structure. Coupling member or protrusion 62 can extend from the chassis 36. A four-bar parallelogram linkage 68 can couple the protrusion 62 on the slewing ring to a rotation pivot 70 on each bogie. The combination of linkage 68 and the ring bearings can allow adjustment of the load. Linkage 68 preferably includes an arcuate or boomerang shaped link 72 having a first portion 72a and a second portion 72b. Portions 72a and 72b are preferably unitarily attached using member 72c, but do not need to be unitary and can be coupled together in any manner desired. Linkage 68 also can include U-shaped linkage 74. Each link is driven by a dedicated hydraulic actuator 76, such that as the actuator extends, the chassis 36 lowers relative to the bogie. Preferably one end of the actuator is coupled to protrusion 75 at point 77 and the opposite end is coupled to the rotation pivot 79; however, the actuator can be configured in any suitable manner. The actuator may be either a conventional hydraulic servoactuator, or a counterbalance cylinder concentric and working in parallel with a smaller servoactuator or an electromechanical actuator or any other similar means of actuation. The lifting mechanism can be any suitable mechanism and does not need to include all of the above described elements.

The actuators 76 preferably have a dynamic lifting capacity of at least 200,000 lb each with a 8-inch bore and a 38-inch stroke, but can have any suitable size, configuration and lifting capacity. The bogie travel in the vertical direction is preferably about six feet, but can be any suitable distance. In particular, the conventional servoactuators can be hydraulic actuators with integral position feedback and pressure transducers for load feedback that lift and support the payload.

In another embodiment, counterbalanced actuators can be utilized, which are smaller hydraulic actuators connected to a constant pressure source to lift and support a significant portion of the payload weight. That is, the large conventional servo actuators could be replaced by a smaller counterbalance actuator with a smaller servo actuator mechanically connected in parallel. The counterbalance actuator will support most of the payload's dead weight with the smaller servo actuator only required to actively position the payload

Additionally, two inter-connect cables between the two independent vehicles can be connected, one at the front of the building or load and one at the back, so that the vehicles can operate as one unit in the master-slave arrangement. Once in this configuration, the load can be lifted by the vehicle. However, it is noted that the vehicles can couple in any suitable manner (e.g., wirelessly) and/or at any suitable time and do not necessarily need to be electrically coupled in this manner (or at all) or approach and position themselves in this manner.

As shown in FIG. 4, one end of each independent vehicle has a driver's cabin 42 situated over the bogie and is configured to rotate in any suitable manner. For example, each cabin can rotate up to and including 180 degrees (or any other suitable amount) or, alternatively, the driver and his seat can rotate relative to the cabin. Preferably, the driver's cabin is situated to be a high visibility air conditioned station that allows the driver to control the independent vehicle; however, the driver's cabin can be any suitable steering platform and can be positioned in any suitable area of the vehicle. Additionally, it is not necessary for each vehicle 32 and 34 to have a driver's cabin or steering ability and only one of the vehicles can be equipped with such capabilities or the vehicle can have no on board driver and be remote controlled (wired or wirelessly), controlled via artificial intelligence or computer, run on a track or follow a preprogrammed course or by any other suitable means.

When equipped with on board drivers, two operators, one in each cab, preferably control the vehicle's motion while communicating to each other over headsets; however it is not necessary for the operators to communicate in the manner, to communicate at all or for there even to be two operators; however the vehicle can be operated in any suitable manner. The vehicle can operate with any suitable number of operators and/or the operators can be positioned remotely from the vehicle and communicate with the vehicle from wired or wireless means or the vehicles can be computer controlled or automated. From each of the operators' points of view, each feels as if they are driving their own corner of the vehicle via a steering wheel or joystick on the console (not shown) or using other suitable device(s). The onboard computer system achieves such operation by generating steering and speed commands for all four bogies based on the input of the two joysticks. In this way, the operators can navigate fairly tight corners. The overall velocity is governed primarily by the master (front) operator. Both operators can maintain pressure on a dead-man enable switch (not shown) to enable motion, if desired.

In each mode of operation, the desired velocity vector can be calculated at each moment based on inputs from the operators and the control or computer control system. Each vehicle 32 and 34 can have a computer control that controls each vehicle when operating individually. In other words, when the vehicles are not engaged with each other, each operator is capable of individually steering a respective vehicle using the input controls and the computer control system. However, each control system is designed and configured to electrically couple or interface with the other computer control system, and thereby control the overall direction and speed of the vehicle 30. One system is designated as the dominate or the master system, either automatically or manually. The computer control system can include an onboard guidance and navigation systems. A Global Positioning System (GPS) can be used to facilitate calculation of the vehicle position in relation to the instant center, if desired. Additionally, the vehicle can use differential GPS with two or more receivers (preferably at least one on each transport vehicle 32 and 34) and a laser-based beacon detector for more precise handling and control; however, it is noted that one GPS, multiple GPSs and/or a laser-based beacon detector can be each be used alone or in combination with each other or not at all, if desired. Furthermore, the vehicle 10 and each individual vehicle 32 and 34 can be controlled and/or steered and/or directed in any suitable manner.

As noted above, differential steering can be used to advance and rotate the vehicle as required. To minimize stresses on the vehicle and payload, algorithms can be used to ensure the bogies steer in a kinematically consistent manner to avoid “fighting” one another. The preferred algorithm, called “countersteering”, transforms operator inputs from any two devices (steering wheel, throttle, joysticks) into 3 vehicle overall commands: longitudinal speed of a reference point on the vehicle, lateral speed of the same reference point on the vehicle, and vehicle yaw rate. The countersteering algorithm transforms the 2 operator inputs into 3 overall commands using an “instant center” calculation. The instant center may be on a line passing through the rear bogies (front wheel steer), on a line passing laterally through the midpoint of the vehicle (“four wheel steering”) or, more generally, on a lateral line located anywhere fore or aft of the center of the vehicle. However, it is noted that it is not necessary to steer the vehicle 10 in this manner and the vehicle can be merely steered by the operator or operators or computer control or other suitable means.

Preferably, the vehicle 30 has two speed ranges available to the master operator through a selection lever in the main cab: “Low” and “High”. Low speed is less restricted with respect to steering and maneuvering, but more restricted with regard to speed. While Low is selected, the steering limit hard stops are retracted allowing full steering range. The hard stops limit the articulation of the bogies. In High range or restricted movement mode, the full range of speeds is available to the operator, but the steering hard stops are engaged. This is a safety feature to guard against a failure of a propulsion motor when traveling at an elevated speed causing the bogie to spin too far resulting in damage to the vehicle or the load. However, the restricted movement mode can restrict the movement or any portion or system in of vehicle 10 in any suitable manner. It is noted that having two speed ranges is merely a preferred embodiment and the vehicle can have any number of speed ranges desired, including one or more than two.

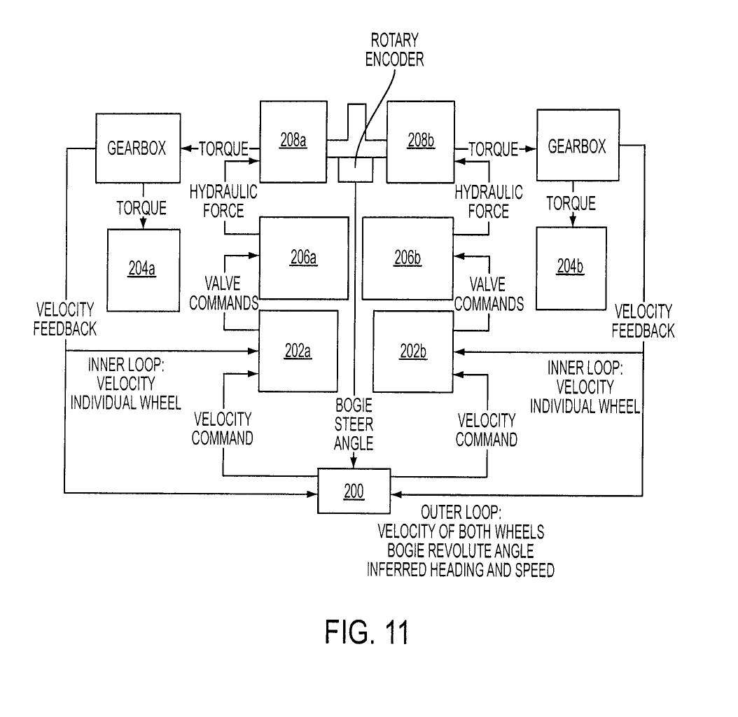

FIG. 11 illustrates an embodiment of the drive system. Vehicle controller 200 is the computer control system that receives data from the operators, GPS receivers and/or the Laser-based beacons or from any other suitable device. The vehicle command is then sent to a controller card 202a and 202b for specific wheel and tire 204a and 204b. Each controller card then sends valve commands to a respective proportional valve 206a and 206b, which in turn sends a hydraulic flow to a respective hydraulic motor 208a and 208b. The hydraulic motors apply torque to a respective gearbox 210a and 210b, which rotate wheels 204a and 204b, respectively. Each gearbox also transmits velocity and direction feedback data to the vehicle controller 200 and to a respective controller card. For example, the data sent to the vehicle controller can include the velocity and direction of the wheels, the bogie revolution angle and the inferred heading and speed, while the data sent to each controller card can include the velocity and direction of an individual wheel. The data sent to the controller cards and the controller can be any data desired and does not need to include or be limited to this exemplary data. Additionally, this steering system is merely an embodiment and does not limit this invention.

With the load loaded, as stated above, one independent vehicle can be selected as the master and the other as the slave using a selection switch on each console or any in other suitable manner. While operating in “cruise mode”, the cab at the front is typically the master and the one at the rear is the slave; however, the vehicle can be operated in any suitable manner. When entering “cruise mode”, an onboard computer system can confirm that the two inter-connect cables are attached and that one cab is set as master and one is set as slave. The onboard computer system can also confirm that all load sensors are within nominal range and that the load is level and/or planar within tolerance as well as other suitable tests as may be required to verify that it is safe to change modes. At this point, the master cab operator can begin moving the vehicle.

Preferably, the load is maintained in a substantially planar and/or substantially level position throughout its conveyance to a predetermined position or location. Sensors or other suitable means monitor the angle of the load with respect to a gravity vector while other sensors or means measure the pitch angle induced on the bogies due to the slope of the ground. Based on this input, the onboard computer system causes the servoactuators 76 at each bogie to adjust accordingly to maintain planarity and level. In all modes, this planarity and leveling action should supersede the travel velocity in so far as the onboard computer system will automatically slow down the wheels to accommodate the leveling response time as necessary. If the system should ever reach the threshold where proper planarity and leveling cannot be maintained, the onboard computer system can command a reduced speed, or, if necessary, invoke an Automatic Stop, bringing forward travel to a halt at a suitable speed or deceleration.

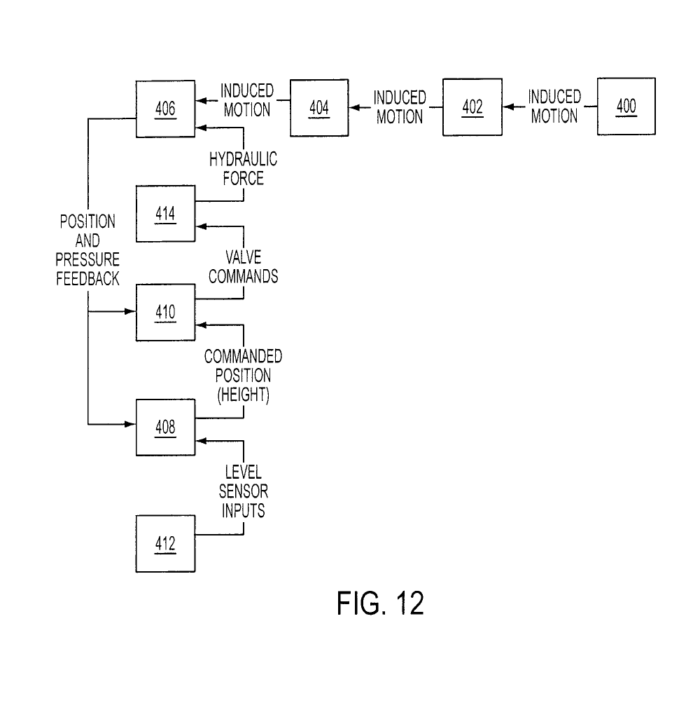

FIG. 12 is a schematic representation of the onboard self-leveling system. This system allows a load or building to be transported from one site (such as the manufacturing or building site) to a second site (such as the graded lot or final position for the building).

When traversing a road surface 400 the roughness or other unevenness of the road can and generally does induce motion through the tire and lift 402, the actuator linkage 404, and actuator 106. Preferably information from each bogie and/or servoactuator 56 is sent to the vehicle controller 408. That is, the leveling system preferably receives data from sensors on each of the four hydraulic cylinders located on each bogie (for example, bogies 32 and 34 and actuator 56); however, the system can receive input from any number of suitable hydraulic actuator sensors or other means. The sensors on the actuators then send signals identifying their position and pressure feedback to both the controller card 410 and the vehicle controller 408. Additionally, at substantially the same time or on a continual basis, leveling sensors and/or planarity sensors (e.g., strain gages attached to the load floor structure or laser alignment devices) 412 send a signal to the vehicle controller. Preferably the leveling sensors and/or planarity sensors 112 send signals at specific intervals; however, the sensors can send signals on any desired schedule. The leveling sensors and/or planarity sensors 412 can include one device or any other number of suitable sensors.

The vehicle controller 408 processes the information from the actuator 106 and the leveling sensors and/or planarity sensors 412 and sends a commanded position to the controller card 410. For example, as stated above, the sensors and/or planarity sensors 412 can be any suitable means for monitoring the angle of the load with respect to a gravity vector and/or other means that measure the planarity of the vehicle chassis using at least three points directly under the slewing ring bearings or other suitable locations.

The controller card 410 then using the data or information received from the vehicle controller 408, the sensors 412 and/or the hydraulic cylinder(s) 406 relays or sends valve commands to the proportional valve(s) 414. The valve(s) in turn control the hydraulic cylinder(s) to adjust the height of the building or portion of the building overlying the specific hydraulic cylinder. Such a system enables the vehicle to continually monitor the position of the building and adjust as the vehicle transports the building to a specific site.

While this leveling and or planarity system is preferably used with a transport vehicle that is formed from two separately joined vehicles, this system can be used with any suitable transport vehicle, including a unitarily constructed vehicle or a vehicle formed from any number of other separately joined vehicles.

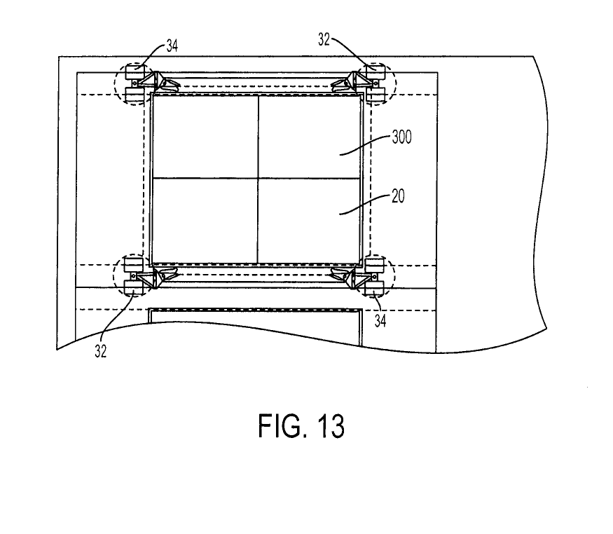

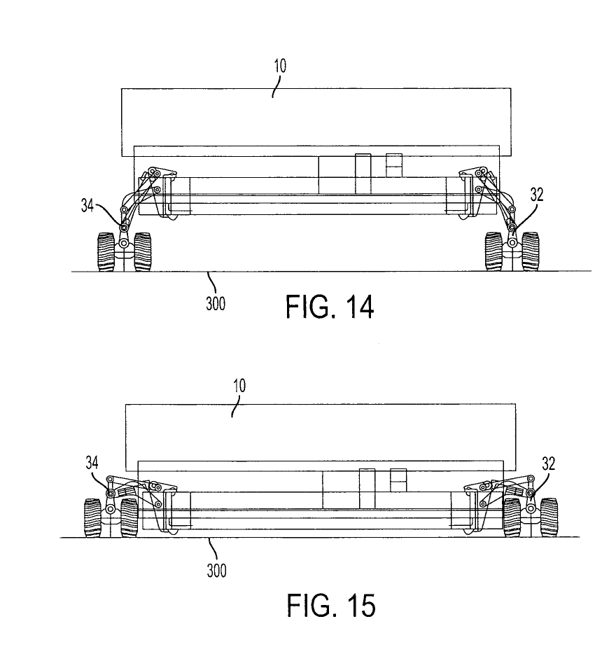

As shown in FIGS. 13-15, once the load is positioned over a predetermined site 300, the load is lowered onto the site. The site can be a graded lot, or a lot having a full, substantially full or partial foundation, merely a dirt or concrete (or other substance) area, or any other suitable final or temporary position for a load.

The four-bar parallelogram linkage 68 and slewing ring structure 62 allow for final positioning of the load over the site 300 in “set mode”. Through coordinated and controlled movement of the slewing ring bearings, combined with controlled movement in a straight line of the bogies along the side edges of the site, the transport device 30 achieves sufficient latitudinal, longitudinal, and rotational movement over a small range to allow the operators to precisely align the load with its site. However, since the load can be placed on a graded site, it is not necessary to have the load placed in a precise manner, and the operators can be given sufficient leeway to place the load within a predetermined area.

The tensioning devices disengage from the bands and each vehicle 32 and 34 is individually driven (manually or automatically) away from the site. The bands can them be removed (or left with the load). If the bands are formed from a plurality of segments, the segments are disconnected and individually removed.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A load, comprising:
a perimeter including a first side and a second side, the second side extending substantially parallel to the first side; and
a plurality of supports extending from the first side to the second side, the supports allowing the load to withstand a lateral compression force suitable to lift the load.

2. A load according to claim 1, wherein
the first and second sides each include a plurality of openings therein.

3. A load according to claim 2, wherein
each of the plurality of openings on the first side is aligned with an opening of the plurality of openings on the second side.

4. A load according to claim 3, further comprising:
a plurality of tendons extending through the plurality of openings in the first and second sides, the plurality of tendons allowing the load to be lifted and moved.

5. A load according to claim 1, wherein
the load is a movable foundation.

6. A load according to claim 5, wherein
the perimeter is formed from concrete.

7. A load according to claim 6, wherein
the plurality of supports are configured to allow the load to withstand a lateral compression force sufficient to lift and transport the load.

8. A movable structure, comprising:
a substantially complete full size non-roadable house, and
a foundation coupled to the substantially complete full size non-roadable house, the foundation including
a perimeter including a first side and a second side, the second side extending substantially parallel to the first side, and
a plurality of supports extending from the first side to the second side, the supports allowing the foundation to withstand a lateral compression force suitable to lift the load.

9. A structure according to claim 8, wherein
the first and second sides each include a plurality of openings therein.

10. A structure according to claim 9, wherein
each of the plurality of openings on the first side is aligned with an opening of the plurality of openings on the second side.

11. A structure according to claim 10, further comprising:
a plurality of tendons extending through the plurality of openings in the first and second sides, the plurality of tendons allowing the movable foundation to lifted and moved.

12. A structure according to claim 8, wherein
the perimeter is formed from concrete.

13. A load according to claim 8, wherein
the plurality of supports are configured to allow the foundation to withstand a lateral compression force sufficient to lift and transport the load.

14. A load, comprising:
a perimeter including a first side and a second side, the second side extending substantially parallel to the first side;
a plurality of openings in the first and second sides, the plurality of openings on the first side aligned with a respective opening on the second side;
a plurality of supports extending from the first side to the second side, the supports allowing the load to withstand a lateral compression suitable to lift the load; and
a plurality of tendons extending through the plurality of openings in the first and second sides, the plurality of tendons allowing the load to be lifted and moved.

15. A load according to claim 14, wherein
the load is a movable foundation.

16. A load according to claim 15, wherein
the perimeter is formed from concrete.

17. A load according to claim 15, wherein
the movable foundation is attached to a substantially complete non-roadable house.
